(19) United States
(12) Patent Application Publication
(10) Pub. No.: US 2011/0080286 A1
(43) Pub. Date: Apr. 7, 2011

(54) Means to Avoid Unintentionally Placing Garments in a Washing Machine or a Dryer

(76) Inventor: William Michael Schuster, Houston, TX (US)

(21) Appl. No.: 12/899,222

(22) Filed: Oct. 6, 2010

Related U.S. Application Data
(60) Provisional application No. 61/249,369, filed on Oct. 7, 2009.

(51) Int. Cl. G08B 13/14

(52) U.S. Cl. 340/568.1

(57) ABSTRACT

This invention provides a manner by which a party can avoid unintentionally placing particular pieces of clothing in a washer or dryer. Specifically, this invention comprises the use of a tag to be affixed to a garment that its owner does not want to be put in a washer or dryer and a detection system that alerts the user that the tagged garment has been put in the washer or dryer. The claimed invention comprises use of technology used in the field of electronic article surveillance.

### RELATED APPLICATIONS

This application claims priority of a prior provisional application filed Oct. 7, 2009, Ser. No. 61/249,369, entitled MEANS TO AVOID UNINTENTIONALLY PLACING GARMENTS IN A WASHING MACHINE OR A DRYER, the disclosure of which is incorporated herein in its entirety by reference thereto.

### FIELD OF THE INVENTION

This invention relates, in general, to technologies employed in washing and drying garments.

### BACKGROUND OF THE INVENTION

People have many reasons to not want to put particular pieces of their clothing in either a clothes washing machine or a clothes drying machine. Such reasons include, but are not limited to, shrinking of the clothing, fading of the clothing's coloring, transfer of the clothing's coloring from one garment onto other garments during washing or drying, and washing or drying of clothing that is intended to be cleaned and/or dried solely through means other than household washers or dryers (e.g. dry cleaning, etc.). This invention provides a manner by which a party can avoid unintentionally placing particular pieces of clothing in a washer or dryer. Specifically, this invention comprises a tag to be affixed to a garment that its owner does not want to be put in a washer or dryer and a detection system that alerts the user that the tagged garment has been put in the washer or dryer.

### SUMMARY OF THE INVENTION

The present invention provides a manner by which a party can avoid the washing or drying of a garment that a party does not want washed or dried in a washer or dryer. The invention comprises the use of two parts: (1) a tag to be affixed to a garment (the term “garment” should be herein construed to encompass any article of clothing or other item that a party might not want placed in a washer or dryer) and (2) a detection system that will sound an alarm or otherwise alert the user of the washer or dryer unit that a tagged garment has been placed inside the unit.

### BRIEF DESCRIPTION OF THE DRAWINGS

FIG. 1 is a view of one portion of one embodiment of the invention, specifically a detection system attached to the outside of a washer or dryer.

FIG. 2 is a view of one portion of one embodiment of the invention, specifically a detection system concealed inside of a washer or dryer.

### BRIEF DESCRIPTION OF THE PREFERRED EMBODIMENTS

This invention provides a means to avoid the washing or drying of a garment that a party may not want washed or dried in a washer or dryer. The invention comprises the use of two parts: (1) a tag to be affixed to a garment and (2) a detection system that will sound an alarm or otherwise alert the user of the washer or dryer unit that a tagged garment has been placed inside the unit. This invention includes, but is not limited to, the specific embodiments described herein.

The aforementioned tag is to be affixed by any means to the garment that the user does not want to be washed or dried. The tag, if brought into some specified proximity to the detection system (e.g. coming between two elements of the detection system located on either side of the port into the washing or drying chamber), will cause the detection system to sound an alarm or otherwise alert the user of the washer or dryer unit that a tagged garment has been placed inside the unit.

In various preferred embodiments, the tag might be: (1) waterproof, (2) resistant to bleaches, detergents and other chemicals used in the maintenance of garments, (3) small enough to be affixed to a garment such that a wearer would not be able to notice it while wearing the garment, (4) of a nature that an observer of the wearer of a tagged garment would not be able to notice the tag, (5) able to be affixed to a label or other inner area of a garment, (6) able to be turned “on” or “off,” such that the user could choose if (or when) a tag would cause the detection system to alert the user that a tagged garment has come into the proximity of the detection system, (7) manufactured in such a manner that it has attributes that make it easy to visually find (e.g. through the use of neon colors or a shiny finish), or (8) resistant to the heat conditions usually found during washing or drying of clothing.

The tag may be affixed to a garment through the use of, in example, an adhesive, a pin and receptor-type affixation means (wherein a male piece of the tag has a pin that is pushed through the garment to which it is to be affixed and the female piece attaches to the pin such that the male and female pieces are affixed on opposite sides of the garment) (see, e.g., U.S. Pat. No. 6,255,950), or a lanyard-type affixation means (see, e.g., U.S. Pat. No. 7,062,823). These means of affixation may be waterproof or resistant to the heat conditions usually found during the washing or drying of clothing or may have any other attributes of the previously disclosed tag (as described above). Other examples of possible affixation means can be found in U.S. Pat. Nos. 5,949,336, 5,955,951, and 6,518,886 (all patents mentioned in this application are incorporated by reference). Further, such a tag could be interwoven into a garment or otherwise attached to the garment by the garment's manufacturer.

The aforementioned detection system comprises a means to sound an alarm or otherwise alert the user of the washer or dryer if/when a tagged garment is placed inside a washer or dyer. To this end, the detection system may utilize, in example, a speaker or vibrating device. Many detection systems are presently known in the pertinent arts.

As discussed in U.S. Pat. No. 6,472,989 (which is quoted significantly over the next 9 paragraphs), electronic article surveillance (EAS) systems are well known for the prevention of shoplifting. Such systems generally involve the attachment of an alarm-triggering marker or security tag (previously referred to as a tag) to an item of merchandise, and sensor means (previously referred to as a detection system) located adjacent the store entrance and/or exit for detecting the tag. Examples of such tags are disclosed in U.S. Pat. Nos. 3,942,829, 3,995,900, 4,649,397, 4,686,516, 4,774,503, and elsewhere. These detection systems are equally applicable for the present use.

One type of surveillance system, as disclosed for example in U.S. Pat. No. 5,877,728, uses Radio Frequency (RF) based digital signal processing (hereinafter referred to as a “RF system”). When a tag enters the sensor's effective radio frequency detection field, an alarm is triggered that alerts personnel to a possible shoplifting attempt. The tag includes a resonant circuit that disrupts a radio frequency beam directed from a pedestal to a receiver located oppositely across the monitored pedestrian walkway.

For example, radio frequency EAS systems usually include both a transmit antenna and a receive antenna which collectively establish a surveillance zone, and tags which are attached to articles being protected. The transmit antenna generates a variable frequency electromagnetic field within a range of a first predetermined frequency. The resonant circuit of the tag is usually comprised of an antenna and diode, or antenna and capacitor, and has a predetermined resonant frequency. When one of the tags is present in the surveillance zone, the field generated by the transmit antenna induces a voltage in the resonant circuit in the tag, which causes the resonant circuit to generate an electromagnetic field field, causing a disturbance in the field within the surveillance zone. The receive antenna detects the electromagnetic field disturbance and generates a signal indicating the presence of the tag (and thus, the protected article attached to the tag) in the surveillance zone.

A second type of electronic shoplifting surveillance system utilizes magnetic and acousto-magnetic merchandise tags for disrupting the signal from a sensor's detection field (hereinafter referred to as a “magnetic system”). Such tags contain two pieces of thin metal that are caused to vibrate within the detection field. The vibration produces a disruptive frequency which interacts with a store exit detector.

Typically a magnetic system marker consists of a first elongated element of high magnetic permeability ferromagnetic material disposed adjacent to at least a second element of ferromagnetic material having higher coercivity than the first element. When subjected to an interrogation frequency of electromagnetic radiation, the marker causes harmonics of the interrogation frequency to be developed in the receiving coil. The detection of such harmonics indicates the presence of the marker.

A third type of EAS system (hereinafter referred to as a “harmonic system”) employs magnetic harmonic markers which include a thin strip or wire of magnetic material that responds to an alternating interrogation signal by generating a signal pulse that is rich in high harmonics of the interrogation signal. Such markers are disclosed in U.S. Pat. Nos. 4,660,025 and 4,980,670.

A fourth type of EAS system employs magnetomechanical markers that include a magnetostrictive element (hereinafter referred to as a “magnetostrictive system”). For example, U.S. Pat. No. 4,510,489 discloses a marker formed of a ribbon-shaped length of a magnetostrictive amorphous material contained within a hollow recess in an elongated housing in proximity to a biasing magnetic element. The magnetostrictive element is fabricated such that it is mechanically resonant at a predetermined frequency when the biasing element has been magnetized to a certain level. At the interrogation zone, a suitable oscillator provides an AC magnetic field at the predetermined frequency, and the magnetostrictive-element mechanically resonates at this frequency upon exposure to the field when the biasing element has been magnetized to the aforementioned level. The resulting signal radiated by the magnetostrictive element is detected by detecting circuitry provided at the interrogation zone.

EAS systems which use magnetomechanical markers have proved to be very effective and are in widespread use. Systems of this type are sold under the brand name “Ultra*Max”. In operating such systems, it is customary to attach magnetostrictive markers to the items of merchandise at retail stores which maintain equipment for generating the field for the interrogation zone. The attachment of the markers to the items of merchandise is typically carried out by means of a pressure sensitive adhesive layer provided on the marker, or, when the marker is intended to be removable, by a mechanical clamping device or the like. One example of such a device is disclosed in U.S. Pat. No. 5,031,756, issued to Buzzard et al., which is directed to a “keeper” which may be utilized in a retail store. The keeper includes a frame for holding a compact disk or similar item until the compact disk is paid for at a checkout counter. The keeper disclosed by Buzzard et al. includes an EAS marker which may be a magnetomechanical marker of the type described in the Anderson et al. patent.

U.S. Pat. No. 5,392,028 concerns a merchandise tag which incorporates two different kinds of EAS markers, namely the resonant circuit of the first above-mentioned system, and a magnetizable strip, as in the above-mentioned third system.

A fifth type of EAS system involves microwave activation.

The above described detection systems are not meant to be limiting, but rather are examples of the technology that may be employed in the present invention. Other means may be recognized by one skilled in EAS technology, and such means represent other embodiments of the present invention.

The detection system may be powered by, in example, plugging into an electrical outlet (directly or by being wired into a washing machine or dyer) or by battery power. The detection system may be affixed to a washer or dryer or built into such a unit. If the detection system were affixed to the outside of the washer or dryer, it could be affixed, in example, by use of a magnet or an adhesive. The detection system may sound an alarm or otherwise alert the user of the washer or dryer that a tagged garment has been placed inside a washer or dryer when the tag comes into a specific proximity to the detection system (e.g. within X inches of the detection system) or if the tag comes into a field or area between multiple elements of the detection system. To this end, any technology capable of alerting a user when a specific type of tag is in a specific proximity may be utilized. As referred to above, the detection system could be mounted on the outside of the washer or dryer (e.g. on opposite sides of the port to put in/take out garments from a washer or dyer) or the detection system could be mounted inside a washer or dyer (e.g. mounted just inside the washer or dryer on opposite sides of the port to put in/take out garments from the washer or dryer).

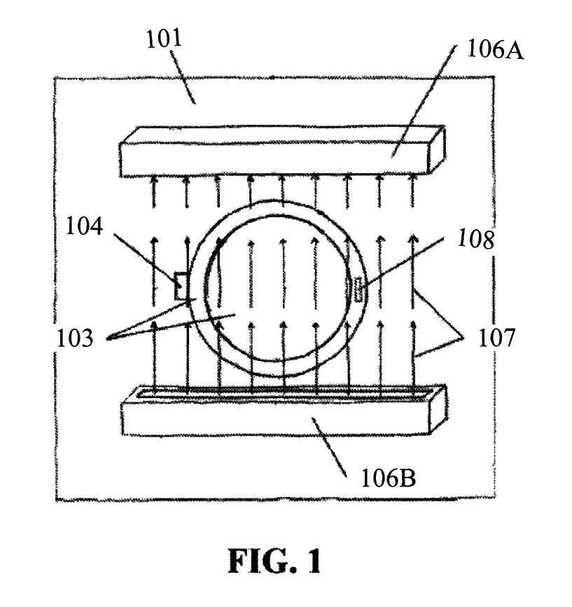

One embodiment of the detection system is depicted in FIG. 1. This figure depicts a two-part detection system (consisting of detection system components 106A, 106B) affixed to the (horizontal or vertical) face of a washer or dryer 101 on either side of a door 103 (comprising a hinge 104 connected to the door 103 and the face of the washer or dryer 101, and a door handle 108) concealing a port through which garments are introduced to the washer or dryer. Should a tagged garment come into the field 107 between the detection system components 106A, 106B, then the detection system will alert the user of this fact. Note that the use of arrows to depict the field 107 is not meant to represent any sort of necessary movement, scope, or orientation of the field or detection system, but rather, these arrows were used to effectively convey the existence of some sort of field existing across the port concealed by the door 103.

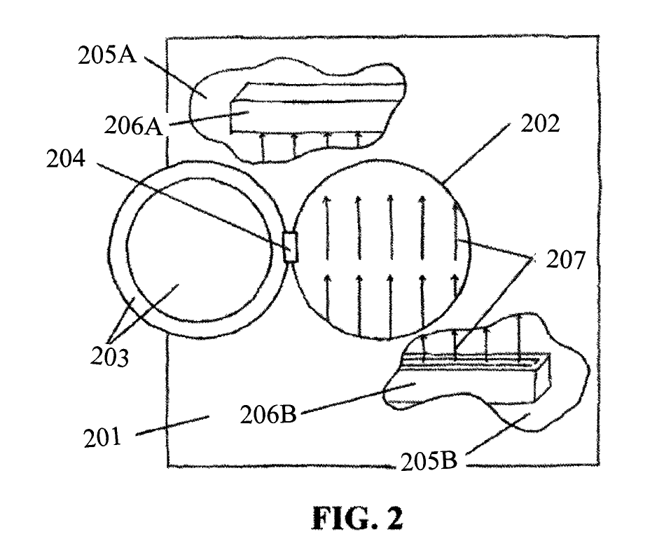

A further embodiment of the detection system is depicted in FIG. 2. This figure depicts a two-part detection system (consisting of detection system components 206A, 206B) concealed inside of a washer or dryer (behind the outside face of the washer or dryer 201) on either side of a port 202 through which garments are introduced to the washer or dryer. Port 202 would be closed off by door 203 (comprising a hinge 204 connected to the door 203 and the face of the washer or dryer 201) during operation of the washer or dryer. The two-part detection system (consisting of detection system components 206A, 206B) concealed inside a washer or dryer would not normally be visible from the outside of the washer or dryer, but FIG. 2 utilizes two cut-away sections, 205A and 205B, to depict the detection system contained inside the washer or dryer. The detection system disclosed in FIG. 2 works in a manner similar to the detection system depicted in FIG. 1, namely, if a tagged garment comes into the field 207 between the detection system components, 206A and 206B, then the detection system will alert the user of this fact. Note that the use of arrows to depict the field 207 is not meant to represent any sort of necessary movement, scope, or orientation of the field or detection system, but rather, these arrows were used to effectively convey the existence of some sort of field existing across port 202. Further, the depiction of the field 207, as only being visible through port 202 or cut-away sections 205A and 205B, is not meant to indicate the that field 207 is necessarily contained behind the face of the washer or dryer 201. Rather, such a depiction of the field 207 is simply meant to indicate that the field 207 is created within the washer or dryer and that the two-part detection system is included as a standard part of the washer or dryer.

It will be apparent to those skilled in the pertinent arts (and it is contemplated) that variations and/or changes in the embodiments illustrated and described herein may be made departure from the present invention.

The invention claimed is:

1. A method for avoiding the unintentional washing or drying of a garment in a washing or drying unit, comprising affixing a tag to the garment wherein the tag will cause a detection system to alert a user of the unit if the garment is placed inside the unit.

2. The method recited in claim 1, wherein the detection system will alert the user of the unit that the garment has been placed inside the unit if the garment comes into a specific proximity to the detection system.

3. The method recited in claim 1, wherein the tag is waterproof.

4. The method recited in claim 1, wherein the tag is resistant to bleaches, detergents and other chemicals used in the maintenance of clothing.

5. The method recited in claim 1, wherein the tag is small enough to be affixed to the garment such that a wearer would not notice the tag while wearing the garment.

6. The method recited in claim 1, wherein the tag is able to be affixed to a label or inner area of the garment

7. The method recited in claim 1, wherein the tag is resistant to the heat conditions usually found during washing or drying of clothing.

8. The method recited in claim 1, wherein the tag can be affixed to the garment through the use of an adhesive.

9. The method recited in claim 8, wherein the adhesive is waterproof.

10. The method recited in claim 8, wherein the adhesive is resistant to the heat conditions usually found during washing and dying of clothing.

11. The method recited in claim 1, wherein the tag can be affixed to the garment through the use of a pin and receptor-type affixation means.

12. The method recited in claim 1, wherein the detection system and the tag comprise a RF system.

13. The method recited in claim 1, wherein the detection system and the tag comprise a magnetic system.

14. The method recited in claim 1, wherein the detection system and the tag comprise a harmonic system.

15. The method recited in claim 1, wherein the detection system and the tag comprise a magnetomechanical system.

16. The method recited in claim 1, wherein the detection system and the tag comprise a system that involves microwave activation.

17. The method recited in claim 1, wherein the detection system is powered by a connection to an electrical outlet.

18. The method recited in claim 1, wherein the detection system is powered by battery power.

19. The method recited in claim 1, wherein the detection system is built into a washer or dryer.

20. The method recited in claim 1, wherein the detection system is affixed to the outside of a washer or dryer.
